(19) United States
(12) Patent Application Publication
(10) Pub. No.: US 2025/0174774 A1
(43) Pub. Date: May 29, 2025

(54) Lithium Secondary Battery and Manufacturing Method of Lithium Secondary Battery

(71) Applicant: Nippon Telegraph and Telephone Corporation, Tokyo (JP)

(72) Inventors: Hironobu Minowa, Musashino-shi, Tokyo (JP); Akihiro Kono, Musashino-shi, Tokyo (JP); Takeshi Komatsu, Musashino-shi, Tokyo (JP)

(21) Appl. No.: 18/714,023

(22) PCT Filed: Dec. 6, 2021
(86) PCT No.: PCT/JP2021/044721

§ 371 Date: May 28, 2024

(51) Int. Cl. H01M 50/131; H01M 4/38; H01M 10/0525; H01M 10/056; H01M 10/0585

(52) U.S. Cl. CPC H01M 50/131; H01M 4/382; H01M 10/0525; H01M 10/056; H01M 10/0585; H01M 2300/0071; H01M 2300/0082; H01M 2300/0091

(57) ABSTRACT

A lithium secondary battery includes: a positive electrode film into which lithium ions can be inserted and from which lithium ions can be eliminated; a negative electrode film that is any one of a negative electrode film of lithium, a negative electrode film made of a material capable of forming an alloy with lithium, and a negative electrode film into which lithium ions can be inserted and from which lithium ions can be eliminated; a transparent and solid electrolyte film that is located between the positive electrode film and the negative electrode film and has lithium ion conductivity; and two transparent substrates sandwiching, between transparent conductive films formed on respective surfaces of the transparent substrates, the positive electrode film and the negative electrode film having the electrolyte film therebetween.

### TECHNICAL FIELD

The present invention relates to a lithium secondary battery and a method for manufacturing a lithium secondary battery.

### BACKGROUND ART

The lithium secondary battery is a battery using insertion and elimination reactions of lithium ions, and is a battery having a high energy density. Such a lithium secondary battery is used in various applications such as a power source of an electronic device, a power source of an automobile, and a power storage source. Currently, research and development on an electrode material and an electrolyte material are still in progress in order to improve performance of the lithium secondary battery and to reduce cost of the lithium secondary battery.

In recent years, with development of a smartphone terminal and an Internet of Things (IoT) device, the lithium secondary battery has attracted more attention as a mobile power source. In addition, the lithium secondary battery is also required to have flexibility and designability of the battery itself as a power source for a transparent display, an ultrathin display, or the like.

Therefore, research and development on a thin lithium secondary battery have been performed (see Non Patent Literature 1).

### CITATION LIST

### Non Patent Literature

Non Patent Literature 1: M. Hayashi, and two others, “Preparation and electrochemical properties of pure lithium cobalt oxide films by electron cyclotron resonance sputtering”, Journal of Power Sources, 189, 2009, p. 416-p. 422

### SUMMARY OF INVENTION

### Technical Problem

However, a conventional lithium secondary battery is only thin and bendable. Meanwhile, if a lithium secondary battery having both characteristics of thinness and transparency and using a material having a high energy density can be achieved, there is a higher possibility that the lithium secondary battery can be used for various devices suitable for device designability, and a range of applications is assumed to be largely expanded.

The present invention has been made in view of the above circumstances, and an object of the present invention is to provide a lithium secondary battery that transmits visible light, has excellent charge/discharge cycle characteristics, and has a high energy density, and a method for manufacturing the lithium secondary battery.

### Solution to Problem

A lithium secondary battery according to an aspect of the present invention includes: a positive electrode film into which lithium ions can be inserted and from which lithium ions can be eliminated; a negative electrode film that is any one of a negative electrode film of lithium, a negative electrode film made of a material capable of forming an alloy with lithium, and a negative electrode film into which lithium ions can be inserted and from which lithium ions can be eliminated; a transparent and solid electrolyte film that is located between the positive electrode film and the negative electrode film and has lithium ion conductivity; and two transparent substrates sandwiching, between transparent conductive films formed on respective surfaces of the transparent substrates, the positive electrode film and the negative electrode film having the electrolyte film therebetween.

A method for manufacturing a lithium secondary battery according to an aspect of the present invention includes: a step of forming a transparent conductive film on a surface of a first transparent substrate and forming a transparent conductive film on a surface of a second transparent substrate; a step of preparing a transparent and solid electrolyte film having lithium ion conductivity; a step of forming, on one surface of the electrolyte film, a positive electrode film into which lithium ions can be inserted and from which lithium ions can be eliminated; a step of forming, on the other surface of the electrolyte film, a negative electrode film that is any one of a negative electrode film of lithium, a negative electrode film made of a material capable of forming an alloy with lithium, and a negative electrode film into which lithium ions can be inserted and from which lithium ions can be eliminated; and a step of superimposing the transparent conductive film of the first transparent substrate on a surface of the positive electrode film and superimposing the transparent conductive film of the second transparent substrate on a surface of the negative electrode film.

### Advantageous Effects of Invention

The present invention can provide a lithium secondary battery that transmits visible light, has excellent charge/discharge cycle characteristics, and has a high energy density, and a method for manufacturing the lithium secondary battery.

### BRIEF DESCRIPTION OF DRAWINGS

FIG. 1 is a cross-sectional view of a lithium secondary battery.

FIG. 2 is a top view of the lithium secondary battery.

FIG. 3 is a flowchart illustrating a method for manufacturing the lithium secondary battery.

FIG. 4 is a diagram illustrating a measurement result of transmittance of the lithium secondary battery.

FIG. 5 is a diagram illustrating an initial charge/discharge curve of the lithium secondary battery.

### DESCRIPTION OF EMBODIMENTS

Hereinafter, an embodiment of the present invention will be described with reference to the drawings. In the drawings, the same parts are denoted by the same reference signs, and description thereof is omitted. The present invention is not limited to the following embodiment and can be appropriately modified and performed without changing the gist and scope of the present invention.

### [Configuration of Lithium Secondary Battery]

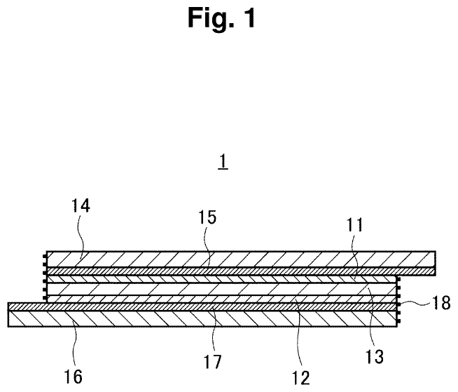

FIG. 1 is a cross-sectional view of a lithium secondary battery 1 according to the present embodiment.

The lithium secondary battery 1 includes a positive electrode film 11, a negative electrode film 12, an electrolyte film 13, a first transparent substrate 14, a first transparent conductive film 15, a second transparent substrate 16, a second transparent conductive film 17, and a sealant 18.

The positive electrode film 11 is a positive electrode film containing a substance into which lithium ions can be inserted and from which lithium ions can be eliminated. Such a positive electrode film 11 can be formed using an existing substance.

The negative electrode film 12 is any one of a negative electrode film containing metallic lithium, a negative electrode film made of a metallic material capable of forming an alloy with lithium, and a negative electrode film containing a substance into which lithium ions can be inserted and from which lithium ions can be eliminated. Such a negative electrode film 12 can also be formed using an existing substance.

The electrolyte film 13 is a transparent and solid electrolyte film that is located between the positive electrode film 11 and the negative electrode film 12, has one of upper and lower surfaces in contact with the positive electrode film 11 and the other in contact with the negative electrode film 12, and has lithium ion conductivity. The electrolyte film 13 only needs to be a solid electrolyte film having visible light transmittability, made of a substance having lithium ion conductivity and having no electron conductivity.

Such an electrolyte film 13 can be formed, for example, by impregnating a separator with a predetermined electrolyte. For example, the separator is impregnated with a polymer electrolyte containing a polymer. The polymer electrolyte may be further impregnated with an organic electrolyte or an aqueous electrolyte, or aluminum oxide or the like may be further added to the polymer electrolyte.

The first transparent substrate 14 is a transparent substrate having visible light transmittability, made of glass or the like.

The first transparent conductive film 15 is made of a substance having visible light transmittability, such as indium tin oxide (ITO), and is formed on one of upper and lower surfaces of first transparent substrate 14.

The second transparent substrate 16 is a transparent substrate having visible light transmittability, made of glass or the like.

The second transparent conductive film 17 is made of a substance having visible light transmittability, such as ITO, and is formed on one of upper and lower surfaces of the second transparent substrate 16.

As illustrated in FIG. 1, the first transparent substrate 14 and the second transparent substrate 16 are disposed so as to sandwich, between the first transparent conductive film 15 and the second transparent conductive film 17 formed on respective surfaces of the first transparent substrate 14 and the second transparent substrate 16, the positive electrode film 11 and the negative electrode film 12 having the electrolyte film 13 therebetween.

The sealant 18 is a sealant that fixes the positive electrode film 11, the negative electrode film 12, the electrolyte film 13, the first transparent substrate 14, the first transparent conductive film 15, the second transparent substrate 16, and the second transparent conductive film 17 so as not to be displaced from each other, and seals the positive electrode film 11, the negative electrode film 12, the electrolyte film 13, the first transparent substrate 14, the first transparent conductive film 15, the second transparent substrate 16, and the second transparent conductive film 17 such that contents of the electrolyte film 13 and the like do not leak to the outside, such as an adhesive or a sealing material.

### [Appearance of Lithium Secondary Battery]

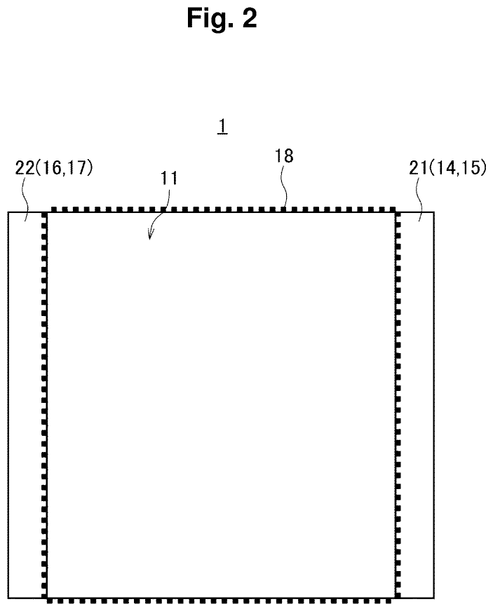

FIG. 2 is a top view of the lithium secondary battery 1 illustrated in FIG. 1.

The first transparent substrate 14 and the first transparent conductive film 15 each have an exposed portion exposed from a battery main portion centered on the electrolyte film 13. The exposed portion serves as an electrode terminal 21 of a positive electrode in the lithium secondary battery 1. The second transparent substrate 16 and the second transparent conductive film 17 also each have an exposed portion. The exposed portion serves as an electrode terminal 22 of a negative electrode. Edges of the first transparent substrate 14, the second transparent substrate 16, and the like are sealed so as to be covered with the sealant 18 such that the electrode terminal 21 of the positive electrode and the electrode terminal 22 of the negative electrode are exposed from the battery main portion.

Since both the first transparent substrate 14 and the first transparent conductive film 15 located immediately below the first transparent substrate 14 have transparency, the positive electrode film 11 inside the battery can sufficiently transmit external visible light. In addition, the negative electrode film 12 located on a back side can also sufficiently transmit external visible light. Furthermore, the transparent electrolyte film 13 can also sufficiently transmit external visible light.

### [Method for Manufacturing Lithium Secondary Battery]

Next, a method for manufacturing the lithium secondary battery 1 according to the present embodiment will be described.

First, a transparent conductive film made of ITO or the like is formed on the entire surface of one surface of a transparent substrate having visible light transmittability, made of glass or the like. Examples of a film forming method include radio frequency (RF) sputtering and vapor deposition.

Next, a positive electrode film into which lithium ions can be inserted and from which lithium ions can be eliminated is formed at a predetermined thickness on one surface (front surface) of a transparent and solid electrolyte film. In addition, a negative electrode film into which lithium ions can be inserted and from which lithium ions can be eliminated is formed at a predetermined thickness on the other surface (back surface) of the electrolyte film.

Thereafter, the positive electrode film and the negative electrode film having the electrolyte film therebetween are sandwiched between the respective transparent conductive films of the two transparent substrates. Finally, the resulting product is sealed with an adhesive so as to cover edges of the substrates such that only an electrode terminal portion of a positive electrode and an electrode terminal portion of a negative electrode are exposed to the outside from a battery main portion.

### Example 1

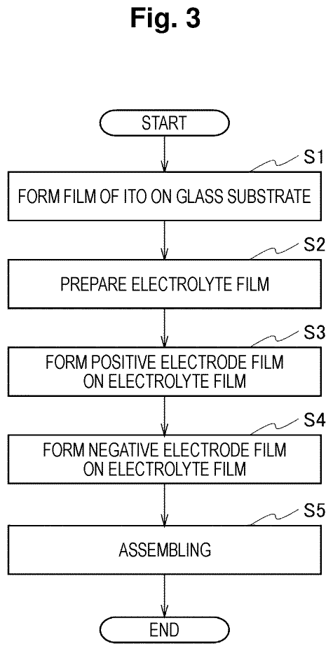

FIG. 3 is a flowchart illustrating a method for manufacturing a lithium secondary battery 1 according to Example 1.

### Step S1;

First, a first transparent conductive film 15 is formed on a surface of a first transparent substrate 14, and a second transparent conductive film 17 is formed on a surface of a second transparent substrate 16. Specifically, each of two glass substrates having a length of 100 mm, a width of 100 mm, and a thickness of 2 mm was coated with ITO at a thickness of 150 nm by an RF sputtering method. Sputtering was performed using an ITO (5 wt % SnO₂) target under an RF output condition of 50 W while argon at 1.0 Pa was caused to flow.

### Step S2;

Next, a transparent and solid electrolyte film 13 having lithium ion conductivity is prepared. Specifically, a solution was prepared by mixing polyvinylidene fluoride (PVdF) powder as a binding material, an organic electrolytic solution in which 1 mol/L of lithium bistrifluoromethanesulfonylimide (LiTFSI) as a lithium salt was dissolved in propylene carbonate (PC), and tetrahydrofuran (THF) as a dispersion medium at a weight ratio of 4:6:10. Then, the solution was stirred in dry air having a dew point of −50° C. or lower at 60° C. for one hour, poured into a 200 @ petri dish in 50 ml portions, and vacuum-dried at 50° C. for 12 hours to prepare a transparent film (transparent polymer electrolyte containing a polymer) having a thickness of 0.1 mm. Thereafter, the transparent film was molded into a size of 90 mm in length×100 mm in width.

### Step S3;

Next, a positive electrode film 11 into which lithium ions can be inserted and from which lithium ions can be eliminated is formed on one surface (front surface) of the electrolyte film 13 prepared in step S2. Specifically, a film of lithium cobalt phosphate (LiCoPO₄) was formed at a thickness of 100 nm on one surface of the electrolyte film prepared in step S2 by an RF sputtering method. Sputtering was performed using a LiCoPO₄ ceramic target under an RF output condition of 100 W while a flow partial pressure ratio between argon and oxygen was 3:1 and a total gas pressure was 3.7 Pa.

### Step S4;

Next, a negative electrode film 12 into which lithium ions can be inserted and from which lithium ions can be eliminated is formed on the other surface (back surface) of the electrolyte film 13 prepared in step S2. Specifically, a film of lithium titanate (Li₄Ti₅O₁₂) was formed at a thickness of 150 nm on the other surface of the electrolyte film prepared in step S2 by an RF sputtering method. Sputtering was performed using a Li₄Ti₅O₁₂ ceramic target under an RF output condition of 100 W while a flow partial pressure ratio between argon and oxygen was 3:1 and a total gas pressure was 4.0 Pa.

### Step S5;

Finally, the first transparent conductive film 15 of the first transparent substrate 14 prepared in step S1 is superimposed on a surface of the positive electrode film 11 formed in step S3. In addition, the second transparent conductive film 17 of the second transparent substrate 16 prepared in step S1 is superimposed on a surface of the negative electrode film 12 formed in step S4.

Specifically, the two ITO-coated glass substrates prepared in step S1 were caused to face each other so as to be superimposed on each other in an area having a size of 90 mm in length×100 mm in width, the electrolyte film in which the positive electrode film and the negative electrode film were formed on respective surfaces of the substrates was sandwiched between the two ITO-coated glass substrates facing each other, and edges of the two ITO-coated glass substrates and the like were sealed with an adhesive. Then, the resulting product was put into a vacuum dryer before the adhesive was solidified and vacuum-dried, and then the adhesive was solidified. The remaining areas of the two ITO-coated glass substrates, each having a size of 10 mm in length×100 mm in width, are used as an electrode terminal of a positive electrode and an electrode terminal of a negative electrode.

Thereafter, in order to measure battery performance, a charge/discharge test was performed on the lithium secondary battery 1 of Example 1 using a commercially available charge/discharge measurement system while a current density per effective area of the positive electrode and the negative electrode was 1 μA/cm². The charge/discharge test was performed in a voltage range of an end-of-charge voltage of 3.4 V and an end-of-discharge voltage of 2.0 V. In the charge/discharge test for the battery, measurement was performed in a thermostatic chamber at 25° C. (atmosphere: a normal air environment).

Note that, in step S4, the negative electrode film into which lithium ions could be inserted and from which lithium ions could be eliminated was formed, but instead of forming the negative electrode film, a negative electrode film containing metallic lithium or a negative electrode film made of a metallic material capable of forming an alloy with lithium may be formed.

### Comparative Example

In order to grasp battery performance of the lithium secondary battery 1 of Example 1, a lithium secondary battery having a non-transparent electrolyte film 13 was prepared as Comparative Example.

### (ITO-Coated Glass Substrate)

Two ITO-coated glass substrates were prepared in a similar procedure to that in Example 1.

### (Positive Electrode)

A positive electrode was formed by forming a film of lithium cobalt phosphate (LiCoPO₄) at a thickness of 100 nm by an RF sputtering method in an area of one of the ITO-coated glass substrates, having a size of 90 mm in length×100 mm in width. Sputtering was performed using a LiCoPO₄ ceramic target under an RF output condition of 100 W while a flow partial pressure ratio between argon and oxygen was 3:1 and a total gas pressure was 3.7 Pa.

### (Negative Electrode)

A negative electrode was formed by forming a film of lithium titanate (Li₄Ti₅O₁₂) at a thickness of 150 nm by an RF sputtering method in an area of the other of the ITO-coated glass substrates, having a size of 90 mm in length×100 mm in width. Sputtering was performed using a Li₄Ti₅O₁₂ ceramic target under an RF output condition of 100 W while a flow partial pressure ratio between argon and oxygen was 3:1 and a total gas pressure was 4.0 Pa.

### (Electrolyte)

An electrolyte was formed by forming a film of lithium phosphate (Li₃PO₄) at a thickness of 100 nm on the entire surface of the LiCoPO₄ positive electrode film by an RF sputtering method. Sputtering was performed using a Li₃PO₄ ceramic target under an RF output condition of 100 W while a flow partial pressure ratio between argon and oxygen was 3:1 and a total gas pressure was 3.7 Pa. From above the electrolyte thus prepared, 30 μL of an organic electrolytic solution in which 1 mol/L of lithium bistrifluoromethanesulfonylimide (LiTFSI) as a lithium salt was dissolved in propylene carbonate (PC) was poured into a center of the ITO-coated glass substrate, and the ITO-coated glass substrate was fixed onto a rotating table and then rotated at 50 rpm to cast the electrolytic solution.

### (Preparation of Battery)

Finally, the negative electrode prepared above was superimposed on the electrolyte such that ITO was exposed from a battery main portion, and an edge having a size of 90 mm in length×100 mm in width where the positive electrode, the electrolyte, and the negative electrode were superimposed on each other was sealed with an adhesive. Then, the resulting product was put into a vacuum dryer before the adhesive was solidified and vacuum-dried, and then the adhesive was solidified.

Thereafter, the lithium secondary battery of Comparative Example was subjected to a charge/discharge test under the same conditions as in Example 1.

### [Charge/Discharge Test Results of Example 1]

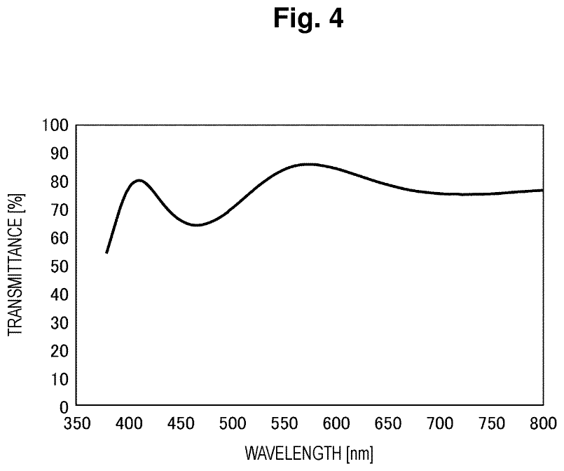

FIG. 4 illustrates a measurement result of transmittance of the lithium secondary battery 1 of Example 1 in a visible light region. The transmittance of 60% or more is exhibited in a visible light region having a wavelength of 400 nm or more, and it can be found that the lithium secondary battery 1 of Example 1 transmits visible light.

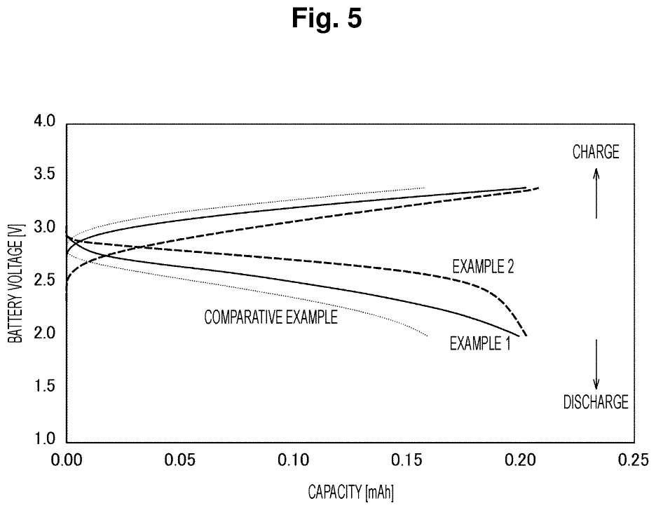

FIG. 5 illustrates initial charge/discharge curves of the lithium secondary batteries of Example 1 and Comparative Example. It can be found that the lithium secondary battery of Example 1 has a smaller irreversible capacity, that is a difference between a charge capacity and a discharge capacity, than that of Comparative Example. The lithium secondary battery of Example 1 exhibited a charge/discharge capacity of about 0.199 mAh and an average discharge voltage of about 2.5 V. This is considered to be because transmission of lithium ions in the electrolyte film 13 was promoted by imparting transmittability to the electrolyte film 13, a capacity was improved, and an energy density per unit capacity was increased.

Meanwhile, the lithium secondary battery of Comparative Example has a lower charge/discharge capacity, a lower discharge voltage, and a higher charge voltage than those of Examples. This is considered to be due to ion conductivity of the electrolyte and an increase in resistance due to contact at an interface between the electrolyte and the positive electrode/negative electrode.

### Example 2

In Example 1, a polymer electrolyte was used as the electrolyte film 13. In Example 2, a polymer electrolyte containing aluminum oxide is used. A lithium secondary battery 1 according to Example 2 was also prepared in a similar procedure to that in Example 1.

### (ITO-Coated Glass Substrate)

Two ITO-coated glass substrates were prepared in a similar procedure to that in Example 1.

### (Electrolyte)

A solution was prepared by mixing polyvinylidene fluoride (PVdF) powder as a binding material, an organic electrolytic solution in which 1 mol/L of lithium bistrifluoromethanesulfonylimide (LiTFSI) as a lithium salt was dissolved in propylene carbonate (PC), tetrahydrofuran (THF) as a dispersion medium, and aluminum oxide (Al₂O₃) as a dispersion medium at a weight ratio of 4:6:10:0.3. Then, the solution was stirred in dry air having a dew point of −50° C. or lower at 60° C. for one hour, poured into a 200Φ petri dish in 50 ml portions, and vacuum-dried at 50° C. for 12 hours to prepare a transparent film (polymer electrolyte containing aluminum oxide) having a thickness of 0.1 mm.

### (Preparation of Battery)

The polymer electrolyte was molded into a size of 90 mm in length×100 mm in width, a positive electrode into which lithium ions could be inserted and from which lithium ions could be eliminated was formed on one surface (front surface) of the polymer electrolyte, and a negative electrode into which lithium ions could be inserted and from which lithium ions could be eliminated was formed on the other surface (back surface). Then, the resulting product was sandwiched between the two ITO-coated glass substrates such that the entire positive electrode and the entire negative electrode were covered, and an edge having a size of 90 mm in length×100 mm in width where the positive electrode, the electrolyte, and the negative electrode were superimposed on each other was sealed with an adhesive. Then, the resulting product was put into a vacuum dryer before the adhesive was solidified and vacuum-dried, and then the adhesive was solidified.

Thereafter, the lithium secondary battery of Example 2 was subjected to a charge/discharge test under the same conditions as in Example 1.

### [Charge/Discharge Test Results of Example 2]

FIG. 5 illustrates initial a charge/discharge curve of the lithium secondary battery according to Example 2. The lithium secondary battery according to Example 2 was chargeable and dischargeable, and exhibited a charge/discharge capacity of about 0.203 mAh and an average discharge voltage of about 2.7 V. The lithium secondary battery according to Example 2 has a higher charge/discharge capacity, a higher discharge voltage, and a lower charge voltage than those of Example 1. This is considered to be because addition of aluminum oxide increased ion conductivity of the electrolyte and reduced internal resistance.

### Effects of Embodiment

According to the present embodiment, the lithium secondary battery 1 includes: the positive electrode film 11 into which lithium ions can be inserted and from which lithium ions can be eliminated; the negative electrode film 12 that is any one of a negative electrode film of lithium, a negative electrode film made of a material capable of forming an alloy with lithium, and a negative electrode film into which lithium ions can be inserted and from which lithium ions can be eliminated; the transparent and solid electrolyte film 13 that is located between the positive electrode film and the negative electrode film and has lithium ion conductivity; and the two transparent substrates 14 and 16 sandwiching, between the transparent conductive films 15 and 17 formed on respective surfaces of the transparent substrates 14 and 16, the positive electrode film and the negative electrode film having the electrolyte film therebetween, and therefore a lithium secondary battery that transmits visible light, has excellent charge/discharge cycle characteristics, and has a high energy density can be provided.

In addition, according to the present embodiment, a step of forming a transparent conductive film on a surface of a first transparent substrate and forming a transparent conductive film on a surface of a second transparent substrate; a step of preparing a transparent and solid electrolyte film having lithium ion conductivity; a step of forming, on one surface of the electrolyte film, a positive electrode: film into which lithium ions can be inserted and from which lithium ions can be eliminated; a step of forming, on the other surface of the electrolyte film, a negative electrode film that is any one of a negative electrode film of lithium, a negative electrode film made of a material capable of forming an alloy with lithium, and a negative electrode film into which lithium ions can be inserted and from which lithium ions can be eliminated; and a step of superimposing the transparent conductive film of the first transparent substrate on a surface of the positive electrode film and superimposing the transparent conductive film of the second transparent substrate on a surface of the negative electrode film are performed, and therefore a method for manufacturing a lithium secondary battery that transmits visible light, has excellent charge/discharge cycle characteristics, and has a high energy density can be provided.

### INDUSTRIAL APPLICABILITY

The lithium secondary battery 1 according to the present embodiment can be used as a power drive source and a power supply source for an electronic device or the like, and can be used in various industries using a battery.

### REFERENCE SIGNS LIST

1 Lithium secondary battery
11 Positive electrode film
12 Negative electrode film
13 Electrolyte film
14 First transparent substrate
15 First transparent conductive film
16 Second transparent substrate
17 Second transparent conductive film
21 Electrode terminal of positive electrode
22 Electrode terminal of negative electrode

1. A lithium secondary battery comprising:
a positive electrode film into which lithium ions can be inserted and from which lithium ions can be eliminated;
a negative electrode film that is any one of a negative electrode film of lithium, a negative electrode film made of a material capable of forming an alloy with lithium, and a negative electrode film into which lithium ions can be inserted and from which lithium ions can be eliminated;
a transparent and solid electrolyte film that is located between the positive electrode film and the negative electrode film and has lithium ion conductivity; and
two transparent substrates sandwiching, between transparent conductive films formed on respective surfaces of the transparent substrates, the positive electrode film and the negative electrode film having the electrolyte film therebetween.

2. The lithium secondary battery according to claim 1, wherein the electrolyte film contains a polymer.

3. The lithium secondary battery according to claim 2, wherein the electrolyte film further contains aluminum oxide.

4. A method for manufacturing a lithium secondary battery, the method comprising:
a step of forming a transparent conductive film on a surface of a first transparent substrate and forming a transparent conductive film on a surface of a second transparent substrate;
a step of preparing a transparent and solid electrolyte film having lithium ion conductivity;
a step of forming, on one surface of the electrolyte film, a positive electrode film into which lithium ions can be inserted and from which lithium ions can be eliminated;
a step of forming, on the other surface of the electrolyte film, a negative electrode film that is any one of a negative electrode film of lithium, a negative electrode film made of a material capable of forming an alloy with lithium, and a negative electrode film into which lithium ions can be inserted and from which lithium ions can be eliminated; and
a step of superimposing the transparent conductive film of the first transparent substrate on a surface of the positive electrode film and superimposing the transparent conductive film of the second transparent substrate on a surface of the negative electrode film.
